(19) United States
(12) Patent Application Publication
(10) Pub. No.: US 2016/0186634 A1
(43) Pub. Date: Jun. 30, 2016

(54) EXHAUST AFTER-TREATMENT SYSTEM FOR AN INTERNAL COMBUSTION ENGINE

(71) Applicant: Caterpillar Inc., Peoria, IL (US)

(72) Inventors: Sylvain J. Charbonnel, Peoria, IL (US); Edward L. Kane, Peoria, IL (US); Bret H. RempelEwert, Peoria, IL (US)

(73) Assignee: Caterpillar Inc., Peoria, IL (US)

(21) Appl. No.: 15/065,885

(22) Filed: Mar. 10, 2016

(51) Int. Cl. F01N 3/36; F02B 37/18

(52) U.S. Cl. CPC F01N 3/36; F02B 37/18

(57) ABSTRACT

An exhaust after-treatment system for an internal combustion engine is provided having an exhaust passage in fluid communication with the exhaust manifold of the engine. A turbocharger coupled to the exhaust passage is operatively driven by a first portion of exhaust gases exiting the exhaust manifold. A bypass line is disposed parallel to the turbocharger, and fluidly coupled to the exhaust passage upstream and downstream of the turbocharger. The bypass line receives a second portion of the exhaust gases exiting the exhaust manifold. A fuel injector disposed in the bypass line injects a pre-determined amount of fuel in the bypass line to the second portion of the exhaust gases. An exhaust after-treatment module located downstream of the turbocharger and the bypass line receives the mixture of the first portion and the second portion of the exhaust gas.

### TECHNICAL FIELD

The present disclosure generally relates to after-treatment systems for internal combustion engines. More particularly, the present disclosure relates to thermal management of after-treatment systems for internal combustion engines using a turbocharger.

### BACKGROUND

Internal combustion engines have been known to employ turbochargers to improve a volumetric efficiency of the engine. In addition, after-treatment systems may be provided downstream of the turbochargers to reduce emissions for e.g., CO, NOₓ, and/or Particulate matter (PM).

As such, a typical exhaust after-treatment system requires that the temperature of the exhaust stream downstream of the turbocharger be maintained at an elevated value for ensuring efficient functioning of components in the after-treatment system. Such components may include a Diesel Oxidation Catalyst (DOC), and/or a Diesel Particulate Filter (DPF), Selective Catalytic Reduction (SCR), Lean NOx Trap (LNT) provided downstream of the turbocharger.

U.S. Patent Publication No. 2012/0017587 discloses an engine exhaust after-treatment system using a turbocharger. The turbocharger utilizes exhaust stream to drive a turbine coupled to a compressor and for compressing inlet air. The exhaust after-treatment system also includes a bypass passage allowing flow of exhaust stream therethrough while bypassing the turbocharger. A hydrocarbon injector injects diesel fuel in the exhaust stream upstream of the turbocharger. However, the diesel fuel, being in liquid state, may hamper operation of turbocharger due, at least in part, by allowing the diesel fuel to interfere with the turbine blades of turbocharger. Such injection of the diesel fuel may therefore, deteriorate a performance of the turbocharger.

J. P. Patent Publication No. 2014058927 discloses an engine exhaust after-treatment system employing a turbocharger to boost volumetric efficiency of the engine. The turbocharger is configured to receive a flow of exhaust gases exiting the combustion chamber and utilize thermal energy from the exhaust gases to drive a compressor used to compress inlet gases. An exhaust bypass passage is provided in the exhaust after-treatment system; the exhaust bypass passage being configured to bypass the turbocharger. A hydrocarbon injector injects diesel fuel downstream of the turbocharger. However, the diesel fuel, being in liquid state, may take up thermal energy from the exhaust stream exiting the turbocharger. The exhaust stream exiting the turbocharger may therefore, lose a significant amount of thermal energy in the turbocharger and liquid fuel injection downstream of the turbocharger causing a drop in temperature of the exhaust after-treatment system and deteriorating a conversion efficiency of the exhaust after-treatment system.

Hence, there is a need for an exhaust after-treatment system which overcomes the aforementioned drawbacks associated with locating the hydrocarbon injector upstream or downstream of the turbocharger.

### SUMMARY OF THE DISCLOSURE

In an aspect of this disclosure, an exhaust after-treatment system for an internal combustion engine includes an exhaust passage disposed in fluid communication with an exhaust manifold of the engine. The exhaust passage is configured to receive a stream of exhaust gases exiting the exhaust manifold. A turbocharger is fluidly coupled to the exhaust passage. The turbocharger is located downstream of the combustion chamber and is configured to be operatively driven by a first portion of the exhaust gases exiting the exhaust manifold. A bypass line is disposed parallel to the turbocharger. Moreover, the bypass line is fluidly coupled to the exhaust passage upstream and downstream of the turbocharger. The bypass line is configured to receive a second portion of the exhaust gases exiting the combustion chamber. A fuel injector is disposed in the bypass line. The fuel injector is configured to inject a pre-determined amount of fuel in the second portion of the exhaust gases. An exhaust after-treatment module is disposed in the exhaust passage and located downstream of the bypass line. The exhaust after-treatment module is configured to treat the mixture of the first portion and the second portion of the exhaust gas.

### BRIEF DESCRIPTION OF THE DRAWING

FIG. 1 is a schematic representation of an exemplary engine system employing an exhaust after-treatment system, in accordance with an embodiment of the present disclosure; and

FIG. 2 is a schematic representation of an engine controller operatively coupled with the after-treatment system, in accordance with an embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

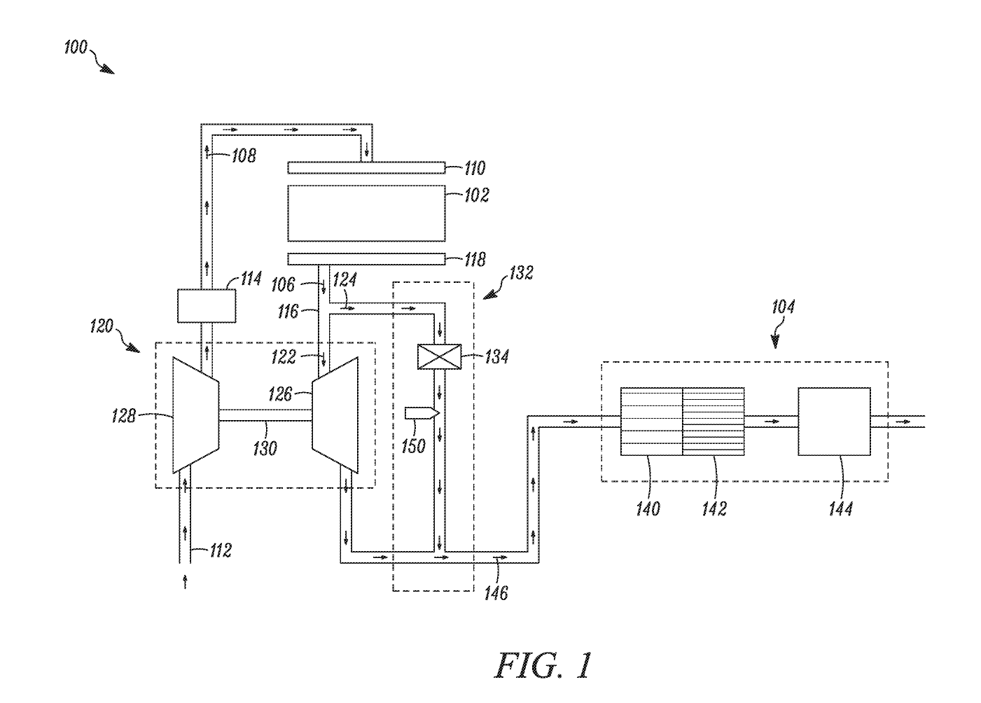

FIG. 1 shows an exemplary engine system 100 including an engine 102 and an after-treatment module 104 to treat an exhaust stream 106 generated as a byproduct of combustion in the engine 102. The engine 102 may be any type of engine (internal combustion, gas, diesel, gaseous fuel, natural gas, propane, etc.), may be of any size, with any number of cylinders, and in any configuration (“V,” in-line, racial, etc.). The engine 102 may be used to power any machine or other device, such as but not limited to on-highway trucks or vehicles, off-highway trucks or machines, earth moving equipment, generators, aerospace applications, locomotive applications, marine applications, pumps, stationary equipment, or other engine powered applications.

As shown in FIG. 1, the engine 102 receives intake air 108 for combustion from an intake manifold 110. The intake may be any suitable conduit or conduits through which gases may flow to enter the engine 102. For example, the intake may include the intake manifold 110, an intake passage 112, and the like. The intake passage 112 receives ambient air from an air filter (not shown) that filters air from atmosphere. The intake air 108 flows through a heat exchanger such as intercooler 114 to reduce the temperature of the intake air 108 before the intake air 108 enters the engine 102 for combustion. The intercooler 114 may be an air-to-air or air-to liquid type heat exchanger. Exhaust gas 106 resulting from combustion in the engine 102 is supplied to an exhaust passage 116 which is in fluid communication with an exhaust manifold 118.

As shown in FIG. 1, the engine system 100 further includes a turbocharger 120 located downstream of the exhaust manifold 118 and arranged between the intake passage 112 and the exhaust passage 116. The turbocharger 120 increases air charge of ambient air drawn into the intake passage 112 in order to provide greater charge density during combustion to increase power output and/or engine-operating efficiency. As such, the turbocharger 120 is driven via the exhaust gas 106 from the engine 102. In an embodiment, the turbocharger 120 receives a first portion of exhaust gases 122 from the exhaust passage 116. The first portion of exhaust gases 122 drive the turbine 126 portion of the turbocharger 120 which is coupled to the inlet air compressor 128 portion of the turbocharger 120 via a drive shaft 130. Subsequently, the first portion of exhaust gases 122 exits the turbocharger 120 via a turbocharger outlet coupled to the exhaust passage 116.

The engine system 100 further includes a bypass line 132 to the exhaust passage 116 located parallel to the turbocharger 120 and coupled to both upstream as well as downstream of the turbocharger 120. The bypass line 132 includes a bypass control element 134 that may be operated to adjust the flow of exhaust gas 106 so that a second portion of exhaust gases 124 is being received in the bypass line 132. By adjusting the flow of exhaust gas 106 in ratio of first portion of exhaust gas 122 and second portion of exhaust gas 124, the amount of energy extracted from exhaust flow through the turbine 126 may be varied. For example, the bypass control element 134 is operably coupled with the bypass line 132 such that a position of the bypass control element 134 governs an extent to which the bypass line 132 is open for passage of fluid such as exhaust gas 106. The bypass control element 134 may be opened, for example, to divert the second portion of exhaust gas 124 away from the turbine 126, and into the bypass line 132. Accordingly, the rotating speed of the compressor 128, and thus the boost provided by the turbocharger 120 to the engine 102 may be regulated. Consequently, the amount of energy extracted by the turbocharger 120 from exhaust flow through the turbine 126 is also adjusted. The bypass control element 134 may be any element that may be selectively controlled to partially or completely block a passage. As an example, the bypass control element 134 may be a gate valve, a butterfly valve, a globe valve, an adjustable flap, or the like.

In an alternative embodiment, the engine cylinders may be divided into two compartments or portions, where exhaust gas from one set of cylinders flows through the turbine 120 and exhaust gas from the second set controllably flows through the turbine 120 based on a position of the bypass control element 134.

As shown in the FIG. 1, the engine system 100 further includes an exhaust after-treatment module 104 to reduce emissions. The exhaust after-treatment module 104 is located downstream of the bypass line 132 and the turbocharger 120. The exhaust after-treatment module 104 includes one or more of a Diesel Oxidation Catalyst (DOC) 140, and a Diesel Particulate Filter (DPF) 142, and various other components 144 such as, but not limited to, a selective catalytic reduction (SCR) catalyst, a Lean NOx Trap (LNT), and/or various other emission control devices or combinations thereof.

The DOC 140 uses a chemical process to reduce hydrocarbons and carbon monoxide (CO) in the exhaust stream 146. The DOC 140 reacts with the hydrocarbons and oxidizes them into less harmful components such as Carbon Dioxide (CO2) and water vapor in the presence of a catalyst. The DPF 142 traps particulate matter that is carried in the exhaust stream 146, preventing the particulate matter from being released into the atmosphere. Inside the DPF 142, particulate matter, sometimes referred to as “soot,” is trapped until it is oxidized during a regeneration process.

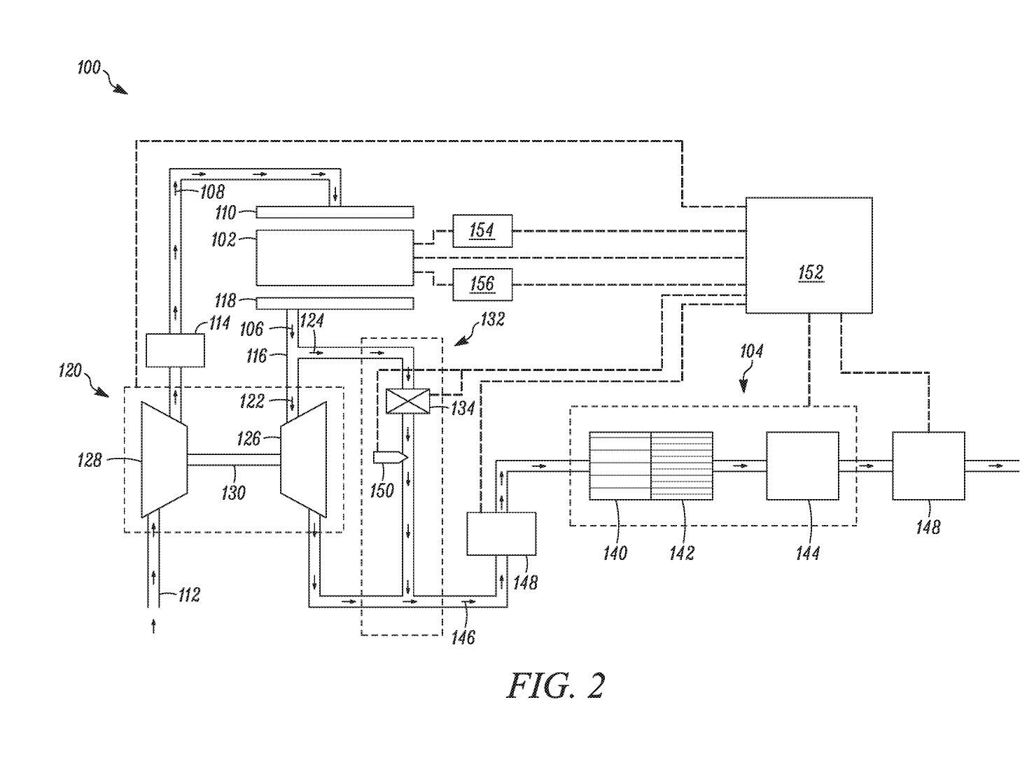

In an embodiment, a particulate load of the DPF 142 may exceed a threshold load, and the engine system 100 may enter the regeneration mode of operation, which is illustrated in detail in FIG. 2. When a particulate load of the DPF 142 exceeds a threshold load, the soot collected in the DPF 142 is burnt off at a high temperature leaving ash as residue. The process of burning off the soot collected in the DPF 142 is generally termed as regeneration. For regeneration of the DPF 142, high temperature exhaust gas is required at the exhaust after-treatment module 104.

As shown in FIG. 1, the engine system 100 includes a fuel injector 150 located in the bypass line 132. The fuel injector 150 may selectively inject a pre-determined amount of fuel to increase a temperature of the second portion of the exhaust stream 124 to a predetermined level. The predetermined level may be based on an effective temperature of the mixture of first portion of exhaust stream 122, exiting the turbocharger 120, and the second portion of exhaust stream 124, exiting the bypass line 132, which is sufficient to carry out the regeneration of the DPF 142. Though the fuel injector 150 is shown to be located downstream of the bypass control element 134, in an embodiment, the fuel injector 150 may be located upstream of the bypass control element 134.

### INDUSTRIAL APPLICABILITY

Generally, a particulate load of the DPF 142 may increase such that regeneration of the DPF 142 needs to be carried out to clean the DPF 142 so that a backpressure on the engine 102 does not increase beyond an allowed level. Further, the DPF 142 is positioned downstream of the turbine 126 of the turbocharger 120 in the exhaust passage 146, an exhaust gas temperature upstream of the DPF 142 and downstream of the turbine 120 may not be high enough to passively regenerate the DPF 142. The fuel injector 150 located in the bypass line 132 may selectively inject a predetermined amount of fuel into a portion of exhaust gas 124 that is being routed through the bypass line 132. This increases the temperature of exhaust gases 146, entering the exhaust after-treatment module 104 to an effective temperature that is required to carry out the regeneration of the DPF 142.

FIG. 2 schematically represents the engine system 100 of FIG. 1 being applied in the context of present disclosure. The exhaust passage 116 receives the exhaust gas stream 106 exiting the exhaust manifold 118. The turbocharger 120 is driven by the first portion of exhaust gases 122. The bypass line 132 located parallel to the turbocharger 120 receives the second portion of exhaust gases 124. The bypass valve 134 located in the bypass line 134 regulates an amount of exhaust gases passing through the bypass line 132. The fuel injector 150 located in the bypass line 132 selectively injects fuel in the second portion of exhaust gases 124 flowing through the bypass line 132. The first and second portion of exhaust gases 122, 124 mix with each other to form a combined exhaust stream 146 which is received by the exhaust after-treatment module 104. The exhaust after-treatment module 104 includes the DOC 140 and the DPF 142 and along with other exhaust after-treatment devices 144. The engine system 100 may also include a sensor module 148 provided in the exhaust passage upstream of the exhaust after-treatment module 104. The sensor module 148 may also be coupled downstream of the exhaust after-treatment module 104. The sensor module 148 may include various types of sensors including, but not limited to, a temperature sensor, a lambda sensor etc. The sensor module 148 may sense various operating conditions of the engine 102 such as but not limited to exhaust gas temperature, oxygen concentration in exhaust gas, amount of particulate matter in exhaust gas and the like.

The engine system 100 also includes a controller 152 operatively connected to various components of the engine system 100. The controller 152 is programmed to predict a threshold value for the mass of soot which collects in the exhaust after-treatment module 104 during operation of the engine 102. The threshold value for the mass of soot is the maximum amount of soot that is allowed to be reached or collected in the exhaust after-treatment module 104 before regeneration of the exhaust after-treatment module 104 is performed. In an embodiment, the threshold value may be established as a function of an operating speed of engine 102 and a quantity of fuel that has entered the engine 102 for combustion. Speed of engine 102 may be sensed by an engine speed sensor 154, while the amount of fuel that has entered the engine 102 may be sensed by a fuel sensor 156. The threshold value of soot may be an amount of soot that has been empirically determined to be the level at which regeneration of exhaust after-treatment module 104 should be performed. Based on the inputs from the engine speed and fuel sensors 154 and 156, and the threshold value of mass of soot, the controller 152 determines a requirement for the regeneration of the exhaust after-treatment module 104.

Further, once the controller 152 determines to perform regeneration of the exhaust after-treatment module 104, the controller 152 is also programmed to monitor exhaust gas temperature T via the sensor module 148. A minimum value of exhaust temperature required to perform regeneration T₀ may be stored in the controller 152. The controller 152 compares the exhaust temperature T measured by the sensor module 148 to the minimum value T₀. If the exhaust temperature T is greater than or equal to T₀, the controller 152 performs the regeneration of exhaust after-treatment module 104. However, if the exhaust temperature T is less than T₀, the controller 152 may not perform the regeneration of exhaust after-treatment module 104 without elevating the exhaust temperature T up to at least T₀.

To elevate the exhaust temperature T up to T₀, the controller 152 commands the fuel injector 150 in the bypass line 132 to inject fuel in the second portion of exhaust stream 124. The amount of fuel to be injected by the fuel injector 150 may be calculated based on a difference in exhaust temperature T and T₀ denoted as dT. Alternatively, a lookup table may be stored in controller 152 memory. The lookup table may have an amount of fuel to be injected in bypass line 132 mapped to the exhaust gas temperature T.

After injecting the fuel in the bypass line 132, the controller 152 again calculates dT to check whether the temperature T has been elevated to T₀. Once the temperature T is greater than or equal to T₀. the controller 152 performs regeneration of the exhaust after-treatment module 104. In case, the temperature T is still less than the temperature T₀, the controller 152 repeats the process of injecting fuel in the bypass line 132 via the fuel injector 150.

Although the above example is explained to determine when the regeneration of the DPF 142 needs to be carried out, it should not limit the scope of the present disclosure, and any process known in the art can be utilized to determine the requirement of regeneration for the DPF 142.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An exhaust after-treatment system for an internal combustion engine, the exhaust after-treatment system comprising:
an exhaust passage disposed in fluid communication with the exhaust manifold, the exhaust passage configured to receive a stream of exhaust gases exiting the exhaust manifold;
a turbocharger fluidly coupled to the exhaust passage and located downstream of the exhaust manifold, the turbocharger being configured to be operatively driven by a first portion of the exhaust gases exiting the exhaust manifold;
a bypass line disposed parallel to the turbocharger and fluidly coupled to the exhaust passage upstream and downstream of the turbocharger, the bypass line being configured to receive a second portion of the exhaust gases exiting the exhaust manifold;
a fuel injector disposed in the bypass line, the fuel injector being configured to selectively inject a pre-determined amount of fuel in the second portion of the exhaust gases; and
an exhaust after-treatment module wherein the exhaust after-treatment module is disposed downstream of the bypass line and the turbocharger, the exhaust after-treatment module configured to receive the mixture of first and second portion of the exhaust streams.
